(19) United States
(12) Patent Application Publication
(10) Pub. No.: US 2003/0138068 A1
(43) Pub. Date: Jul. 24, 2003

(54) Method for transmutation of long-lived radioactive isotopes into short-lived or stable isotopes

(76) Inventors: Vladimir Stepanovich Buttsev, Dubns (RU); Galina Lecnidovna Buttseva, Dubna (RU); Rafail Yakubovich Zoulkarneev, Dubna (RU)

Correspondence Address: Ilya Zborovsky, 6 Schoolhouse Way, Dix Hills, NY, 11746, US

(21) Appl. No.: 10/240,282

(22) PCT Filed: Mar. 28, 2001
(86) PCT No.: PCT/RU01/00125

(30) Foreign Application Priority Data
Mar. 30, 2000 (RU) 2000107659

(51) Int. Cl. G21G 1/06; G21G 1/10

(52) U.S. Cl. 376/190; 376/158

(57) ABSTRACT

The invention relates to nuclear physics and can be used for neutralizing long-lived radioactive isotopes contained, for example, in radioactive waste (RW) of the nuclear engineering. A radioactive isotope undergoes exposure to electromagnetic radiation and a deep ionization of the isotope atoms is performed. Deep ionization of the atoms results in an energy-permitted expedient B-decay thereof prohibited in a neutral state. Measures are taken in order to prevent ionized atoms from recombination with short-lived nucleus. The retention time must be long enough to transmit at least a part of the parent nucleus into the short-lived and stable daughter nucleus. For ensuring a factor k of an operating time of said daughter nucleus, the retention is performed at least during a time Ki, i is a life time of the parent nucleus at the expedient B-decay. A charge-particle beam (electrons, protons or ions) is used for electromagnetic irradiation. The charge-particle beam irradiation can be combined with the photon flux irradiation. The intentive method makes it possible to speed up the transmutation of the long-lived radioactive isotopes without using nuclear collisional reactions accompanied by the production of radioactive co-products.

### FIELD OF THE INVENTION

This invention relates to nuclear physics and can be used for neutralizing the long-lived radioactive isotopes contained, for instance, in radioactive waste (RW) of nuclear engineering.

### DESCRIPTION OF THE BACKGROUND ART

The well-known methods for transmutation of RW containing long-lived isotopes can be divided into passive and active ones.

The passive methods are based on the storage of RW under control for the period of time sufficient for the natural reduction of the radioactivity level to safe values.

One of the passive methods of rendering RW harmless consists in storage of it under control in shielding containers which isolate the RW from the environment. This, method includes deep burying of the shielding containers for the period of time sufficient for rendering RW harmless [1]. This period of lime during which the storage of RW under control is carried out is about 1000 years.

The disadvantage of method [1] is a long period of time necessary for rendering RW harmless, during which the leakage of radioactive products is possible due to the break of leak-tightness of the containers, for example, in the case of tectonic instability or other emergency situations.

Active methods of rendering RW harmless include transmutation of long-lived radioactive components into short-lived or stable ones under the influence of the external field or irradiation [2], [3], [4],[5], [6].

According to methods [2] and [3], the radioactive products are influenced by the external electrostatic field. As a source of electrostatic field (‘irradiator of magnetic mono fields”) the Van de Graaf electrostatic generator is used according to method [2], and according to method [3]—a system of conducting strips rolled-up into the Mebius ribbon.

The disadvantage of methods [2] and [3] is low efficiency (rate) of transmutation. Besides, the absence of reliable physical base for the influence of the electrostatic field on the rate of the radioactive isotope decay, practically excludes the, improvement of these methods.

According to method [4] the long-lived components of the RW are radiated by the beam of fast neutrons produced as the result of interactions between the target-converter and the beam of accelerated protons with the energy of 1-10 GeV, according to method [5]—they are directly radiated by the beam of accelerated protons with the energy of 20-40 MeV, and according to method [6],—by the flow of gamma-quants produced as the result of the magnetic braking of electrons having been accelerated up to ultra relativistic energies.

The general disadvantages of methods [4], [5], and [6] are typical for all transformations based on the nuclear collisional reactions character—i.e. high costs of the transmutation process and production of RW co-products.

There is a well-know method for transmutation of long-lived radioactive isotopes into short-lived or stable isotopes under the influence of electromagnetic, irradiation, which was selected as a prototype [7].

According to method [7] the irradiation is carried out by the RF range radiation with a very high density of the energy flow. This method is carried out by use of the much simpler and cheaper equipment than the equipment required by methods [4], [5], and [6]. The disadvantage of method [7] is a low efficiency of transmutation.

According to method [7], the reduction of time necessary for the radioactive isotope decay (and this characterizes the transmutation efficiency) was 0.65% at the energy flow density 0.5×10⁻² J/cm² and 1.0% at the energy flow density 5×10⁻² J/cm².

### SUMMARY OF THE INVENTION

The general object of the invention is to increase the efficiency of transmutation of long-lived radioactive isotopes.

Another object of the invention is to provide an effective RW transmutation without using nuclear collisional reactions and, thus, to avoid production of RW co-products.

These two objects are achieved by a method of transmutation recited the independent claim.

The particular object of the invention is to provide the transmutation of the given part of the atoms. It is achieved by a method recited in claim 2

The specific object of the invention is to provide an opportunity to select the type of electromagnetic radiation depending on the equipment available. This object is achieved by a method recited in claims 3-6

The invention has one moire object which is to increase additionally the efficiency of transmutation. It is achieved by a method recited in claim 7

### BRIEF DESCRIPTION OF THE DRAWINGS

FIG. 1 is a principal diagram illustrating an example of realizing the method taking into account its perspectives

### DESCRIPTION OF THE PREFERED EMBODIMENT

The proposed method of transmutation is based on the physical phenomenon which consists in the following: deep ionization of atoms changes the parameters of a potential well in which the nucleons of atoms are located. As a consequence the system of nuclear energetic levels in the ionized radioactive atom is shifted relative to the levels of the initial nucleus in the neutral atom. This shift opens the channel of the accelerated Beta-decay in the radioactive ionized atom with the transfer of the parent long-lived nuclei into the daughter short-lived or stable nuclei-isobars with the next ordinal number. For radioactive nuclei in the neutral atom these transfers are forbidden by the law of energy conservation. Due to the fast Beta-decay of nuclei of deeply ionized atoms (ions of the parent isotopes), their life-time appears to be by several times less than the life-time of the nuclei in the neutral atoms under the natural radioactive decay of the initial isotope.

This physical effect is known from [8], [9]. According to the results of these activities, the life-times of the parent nuclei under the decay of ¹⁸⁷Re into ¹⁸⁷Os and of ¹²⁹I into ¹²⁹Xe in the neutral atom are 7×10¹⁰ years and 2.3×l0⁷ years, respectably, and in the completely ionized state of atoms life-times are 14 sec⁻³ and 11 sec⁻³, respectably.

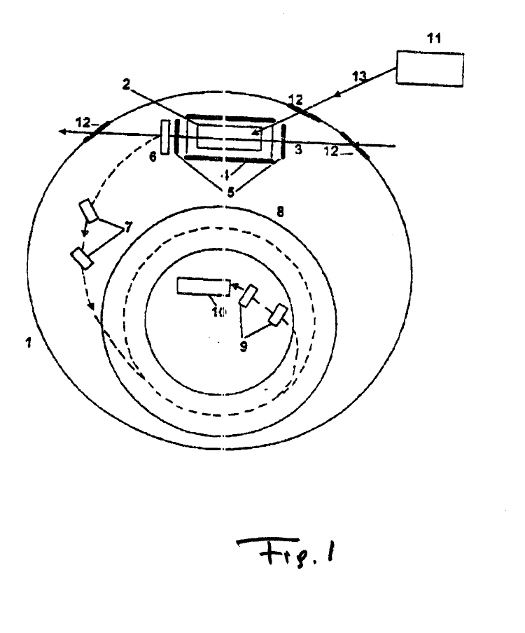

The proposed method can be carried-out, for example, at the installation which principal diagram is presented at FIG. 1.

The designations at FIG. 1 are the following:

1—vacuum chamber,

2—gas target,

3—beam of charged particles,

4—cylindrical electrode,

5—edge electrodes,

6—accelerating electrode,

7—input focusing elements,

8—electromagnetic trap,

9—output focusing elements,

10—container-collector of the transmuted substance,

11—source of photons, for example, a laser,

12—windows of the vacuum chamber,

13—photon flow,

The transmutation is carried out in the following way: A portion of the prepared radioactive substance in the gaseous state is introduced into gas target 2 and located inside vacuum chamber 1. All the facilities realizing the gas target in the vacuum chamber, including the input and output of gas, are described in, for example, [10].

The electromagnetic radiation in a form of charge-article beam 3 moving on the closed orbits crosses gas target 2 many times. This charge-particle beam can be produced, for example, by the accelerator of charged particles [11 ].

Influencing the substance inside target 2, the accelerated particles of beam 3 ionize the atoms of the substance knocking out electrons from the atoms.

Gas target 2 is surrounded by the cylindrical electrode 4 and edge electrodes 5 which have the given potential relative to land. That is why the positive ions of the radioactive substance produced as the result of radiation are locked in gas target 2 by the electric field of positive electrodes 4, 5 and are accumulated in it. Electrodes 4 and 5 should not prevent the radiation and for this purpose they can be fabricated as grids.

Manyfold passages of the charged particles of beam 3 through the atoms of the isotope being transmuted which are kept in gas target 2, cause removal of their electron shells and deep ionization of radioactive atoms which open the channel of the accelerated Beta-decay of their nuclei. In the neutral atom of the isotope being transmuted this channel of the nuclei decay is energetically impossible.

According to the proposed method, the ionized atoms of the radioactive isotope produced in gas target 2 are kept in the ionized state till their transfer (as the result of the Beta-decay of the nuclei) into the atoms of the short-lived or stable isotope.

Keeping the ionized atoms from recombination can be carried out, for example, in the same gas target 2 locked by the field of electrodes 4, 5, or in electromagnetic trap 8.

In the latter case the produced ions of the radioactive substance move from gas target 2 to the electromagnetic trap 8 using the accelerating electrode 6 and focusing elements 7. For this purpose the positive potential is taken off from one of edge electrodes 5 and the negative potential is applied to the next electrode 6. The space of gas target 2 is vacated of the ions and can be filled with a new portion of the substance having been transmuted.

In trap 8 (the device and the principle of action of the electromagnetic trap is described, for example, in [12]), the produced ions of the radioactive substance move in vacuum along the closed orbits and, thus, are kept from recombination till the transfer of them into the atoms of the short-lived or stable isotope. After this the transmuted substance by means of focusing elements 9 is output into container-collector 10 and the trap 8 is vacated for a new portion of the ionized atoms of the parent isotope.

The time necessary for keeping the atoms of the mother isotope in the ionized state is determined by the value T—life-time of the parent isotope under the conditions of the accelerated Beta-decay. If the given degree of reducing the radioactivity level of the substance requires the transmutation of the kN atoms of the initial substance, where k is the coefficient of the generation of the daughter isotope, then the total time of keeping atoms of the mother isotope in the ionized state (in gas target 2 and in trap 8) should exceed KT. As a rule, the keeping time equal to 3t is sufficient for practically completed transmutation of the ionized radioactive isotope.

The charge-particle beams which can be used as electromagnetic radiation are the beam of electrons, or protons, or ions also the photon flow. To increase the efficiency of ionization, the radiation of target 2 by beam 3 of the charged accelerated particles can be brought into coincidence with the additional radiation from the source 11 (for example, the laser) by photon flow 13. Beam 3 and flow 13 pass through transparent windows 12 of vacuum chamber 1.

A total number N of the ions of the parent-isotope with the open channel of the accelerated Beta-decay produced under the influence of radiation, can be determined by formula:

N=6×10²³Ypl6tn/A,

where

Y—intensity of the radiating beam,

p—density of the radiated substance,

l—length of the radiated area,

6— ionization cross section,

t—time of radiation

n—a number of the beam passing through the radiated area,

A—value of the gram-atom of the radiated isotope expressed in grams and numerically equal to its atomic weight.

The estimation of the production rate of the parent ionized atoms under the influence of radiation, for example, by the charged electron beams, is made according to the formula given above, from the values:

Y=10¹³ sec⁻¹, p=10⁻³ G/cm³, l=10 cm, and A=200 g, gives N=3×10 to the 24^{th} degree.

Neglecting the ion losses at the stage of keeping them from recombination and the time of the accelerated Beta-decay of ionized atoms, one can obtain that the productivity shown in FIG. 1 of the diagram of this method is about 1 kg per year, that is comparable with the rate of RW accumulation at middle power nuclear reactors.

As it follows from above, the proposed method allows one to carry out the transmutation of the long-lived radioactive isotopes without using the nuclear collisional reactions and production of RW co-products.

### References and Notes

1. Patent EPB N 0313073, IPC G21K 1/00, 1989

2. Patent of RF N Patent of France N 2358730, IPC G 21F 9/00, published in 1978

3. 2061266, IPC G21F 9/00,1992, published 1996.

4. Patent of France N 2401494, IPC G21F 9/00, published in 1979.

5. Author Certificate USSR N 950073, IPC G21 9/00, 1981 in

6. Patent of RF N 2003191, IPC G21F 9/30, 1995, published in 1993

7. Patent of RF N 2100858, IPC G21F 9/00, 1995, published in 1997.

8. K. Takohashi, K. Yokoi, Nucl. Physics, A 404, 578 (1983).

9. R.Yokoi, M. Arnold. Astron, Astrophysics, 117, 65 (1983).

10. V.D. Bartenev, et al., Proceedings of International Conf. On Instrumentation for High Energy Physics, Dubna, D-5805, p16, 1970.

11. G. I. Budker et al., Proceedings of the X International Conf. On acceleration of Charged Particles of High Energy, Sepukhov, 1947.

12. Physics Encyclopedia. M., Soviet Encyclopedia, 675, 1990.

1. A method for transmutation of the long-lived radioactive isotopes into short-lived or stable isotopes under the influence of electromagnetic radiation, characterized in that the atoms of long-lived radioactive isotope are ionized to such an extent that it is sufficient for the opening of the channel of the accelerated Beta-decay of their nuclei, and that, the ionized atoms with decaying nuclei are kept from recombination.

2. A method as claimed in claim 1, characterized in that the atoms with decaying nuclei are kept in the ionized state, at least, for the period of time kpi, where k—is the given coefficient of the daughter nuclei production, pi-life-time of the parent nuclei under the conditions of the accelerated Beta-decay.

3. A method as claimed in claim 1, characterized in that the beam of accelerated electrons is used as electromagnetic radiation.

4. A method as claimed in claim 1, characterized in that the beam of accelerated protons is used as electromagnetic radiation

5. A method as claimed in claim 1, characterized in that the ion beam can be used as magnetic radiation.

6. A method as claimed in claim 1, characterized in that the flow of photons can be used as electromagnetic radiation.

7. A method as claimed in any of claims 3-5, characterized in that the long-lived radioactive isotope is additionally radiated by the flow of photons.
